(19) United States
(12) Patent Application Publication
(10) Pub. No.: US 2026/0168361 A1
(43) Pub. Date: Jun. 18, 2026

(54) SYSTEMS AND METHODS FOR PRODUCTIVITY ANALYSIS OF OIL AND GAS PRODUCTION SYSTEMS

(71) Applicant: ConocoPhillips Company, Houston, TX (US)

(72) Inventors: Herbert Swan, Houston, TX (US); David D. Cramer, Katy, TX (US); Jonathan R. SNYDER, Houston, TX (US)

(21) Appl. No.: 19/421,410

(22) Filed: Dec. 16, 2025

Related U.S. Application Data
(60) Provisional application No. 63/735,526, filed on Dec. 18, 2024.

(51) Int. Cl. E21B 43/00; E21B 47/06; E21B 47/10; G05B 13/02

(52) U.S. Cl. CPC E21B 43/00; E21B 47/06; E21B 47/10; G05B 13/0265; E21B 2200/20; E21B 2200/22

(57) ABSTRACT

Implementations claimed and described herein provide systems and methods for optimizing natural resource production. The systems and methods use a machine learning model to generate estimated near wellbore friction data associated with pressure and flow rate data.

### CROSS-REFERENCE TO RELATED APPLICATIONS

The present application claims priority to U.S. Provisional Patent Application No. 63/735,526 filed on Dec. 18, 2024, which is incorporated by reference in its entirety herein.

### FIELD

Aspects of the presently disclosed technology relate generally to natural resource production and more specifically to optimization of oil and gas production systems.

### BACKGROUND

Oil and gas production systems use various types of analysis to assess productivity and to plan production systems. Due to the large number of oil and gas production systems, large datasets are created from data received from a variety of data sources, such as, for example, databases and sensors. With such large amounts of data, ascertaining meaningful analytics indicating performance of the systems is challenging. It is with these observations in mind, among others, that various aspects of the present disclosure were conceived and developed.

### SUMMARY

Implementations described and claimed herein address the foregoing problems by providing systems and methods for determining one or more key performance indicators, such as, for example, near wellbore friction (NWBF) of oil and gas production systems using a flow rate, such as for example, slurry rate, and a pressure, such as, for example, a wellhead pressure. The implementations described and claimed herein allow for determining of one or more key performance indicators of oil and gas production systems to facilitate appraisal and maximize value of oil and gas production systems by accelerating optimization of completion design, well spacing and/or stacking, and/or sequencing of fracturing operations (e.g., cross-well distributed acoustic sensing (DAS) strain, diagnostic fracture injection tests (DFIT) simulation and/or interpretation, initial shut-in period (ISIP) analysis, poroelastic response monitoring, and/or water-hammer/tube wave analysis).

In some implementations, a system for optimizing a natural resource production system, the system comprises: a processing system in communication with a computing device, one or more pressure sensors, one or more flow rate sensors, and one or more databases over a network, the computing device having one or more input systems and one or more output systems, the processing system configured to receive pressure data and flow rate data from the one or more pressure sensors and the one or more flow rate sensors; and a well data estimation system having a machine learning model, the well data estimation system configured to generate estimated near wellbore friction data for the pressure data and the flow rate data using the machine learning model.

In some implementations, a method for optimizing a natural resource production system, the method comprising: receiving pressure data from one or more pressure sensors, receiving flow rate data from one or more flow rate sensors, generating estimated near wellbore friction data based on the pressure data and the flow rate sensor data using a machine learning model, and generating output data using the near wellbore friction data.

In some implementations, one or more tangible non-transitory computer-readable storage media storing computer-executable instructions for performing a computer process on a computing system, the computer process comprising: receive pressure data from one or more pressure sensors, receive flow rate data from one or more flow rate sensors, generate estimated near wellbore friction data based on the pressure data and the flow rate sensor data using a machine learning model, and generate output data using the near wellbore friction data.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example communication system.

FIG. 2 illustrates an example processing system.

FIG. 3 illustrates an example computing system that may implement various aspects of the communication system.

FIG. 4 illustrates example operations for optimizing natural resource production system.

FIG. 5 illustrates example operations for generating a graphical representation using the various systems and methods discussed herein.

FIG. 6 illustrates a graphical representation of plots of output data generated using the various systems and methods discussed herein.

FIG. 7 illustrates a graphical representation of plots of pressure generated using the various systems and methods discussed herein.

FIGS. 8 and 9 illustrate a graphical representation of a plot of pressure data generated using the various systems and methods discussed herein.

FIG. 10 illustrates a graphical representation of a plot resulting from removal of a data point using the various systems and methods discussed herein.

FIG. 11 illustrates a graphical representation of a plot of end of stage pressure diagnostics generated using the various systems and methods discussed herein.

FIG. 12 illustrates graphical representations of water hammer analysis generated using the various systems and methods discussed herein.

FIG. 13 illustrates graphical representations of ISIP analysis generated using the various systems and methods discussed herein.

FIG. 14 illustrates graphical representations of ISIP of various wells generated using the various systems and methods discussed herein.

FIG. 15 illustrates a graphical representation of near well-bore friction (NWBF) generated using the various systems and methods discussed herein.

FIG. 16 illustrates graphical representations of a step down analysis generated using the various systems and methods discussed herein.

FIG. 17 illustrates graphical representations of average friction for a plurality of stages generated using the various systems and methods discussed herein.

FIG. 18 illustrates graphical representations of ISIP perf frictions and tortuosity frictions generated using the various systems and methods discussed herein.

FIG. 19 illustrates a graphical representation of production performance of a plurality of wells generated using the various systems and methods discussed herein.

FIG. 20 illustrates a graphical representation of pipe friction during remote frac tests generated using the various systems and methods discussed herein.

FIG. 21 illustrates a graphical representation of surface pipe frictions generated using the various systems and methods discussed herein.

FIG. 22 illustrates graphical representations of step-down inversion of well data generated using the various systems and methods discussed herein.

FIG. 23 illustrates graphical representations of estimated diameters for a plurality of stages generated using the various systems and methods discussed herein.

FIG. 24 illustrates graphical representations of results of step-down tests generated using the various systems and methods discussed herein.

FIGS. 25-27 illustrate graphical representations of fracture-driven interactions generated using the various systems and methods discussed herein.

FIG. 28 illustrates a graphical representation of Volume to First Response (VFR) from Permanent Reservoir Monitoring (PRM) and from the wireline (WL) fiber.

FIG. 29 illustrates a graphical representation of a plot of an end of job step down test analysis generated using the various systems and methods discussed herein.

FIG. 30 illustrates a graphical representation of a plot of different types of fracture-driven interactions.

FIG. 31 illustrates a graphical representations of a parameter plot of a step-down test done at the end of a frac stage that can be generated using the various systems and methods discussed herein.

### DETAILED DESCRIPTION

Aspects of the present disclosure involve systems and methods to process sensor data. The systems and methods described herein generate accurate key performance indicators, such as, for example, near wellbore friction (NWBF) using a flow rate, such as for example, slurry rate, and a pressure, such as, for example, a wellhead pressure, for real time analysis and optimization of oil and gas production systems. This results in a more efficient platform that provides accurate key performance indicators for production systems in the oil and gas industry. Additional advantages of the presently disclosed technology will become apparent from the detailed description below.

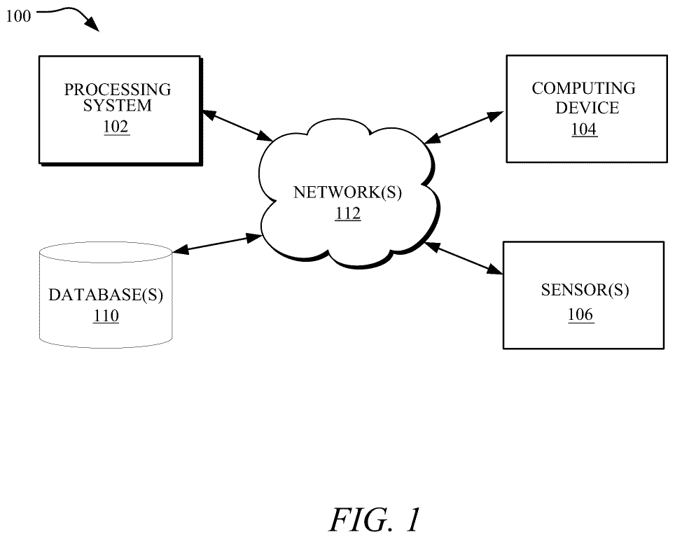

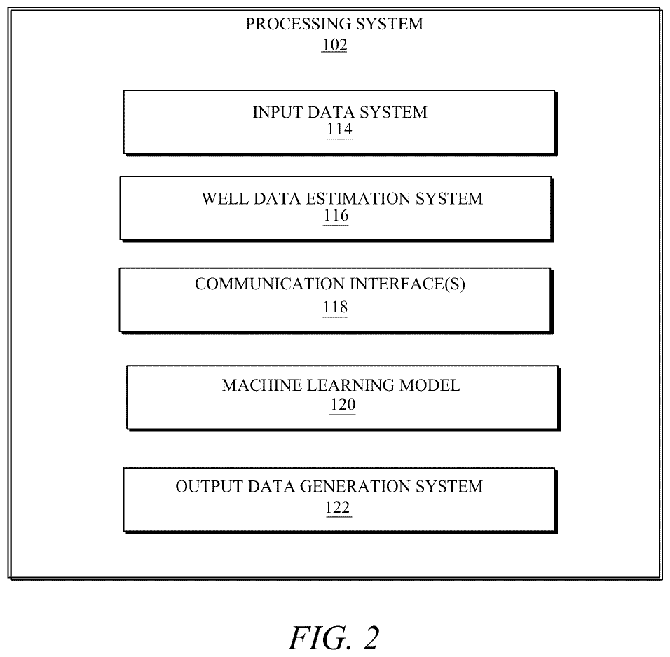

To begin a detailed description of an example system 100 for optimization of oil and gas production systems. In an implementation, the production systems are one or more wells used to extract oil or gas. In an implementation, the system 100 processes sensor data and generates one or more estimated key performance indicators for use in analyzing and optimizing the production systems, reference is made to FIGS. 1-4. In an implementation, the one or more estimated key performance indicators are determined as part of a step-down test. The system 100 can include a processing system 102 configured to receive sensor data. The sensor data is received from at least one of one or more sensors 106 or one or more databases 110. The system 100 is configured to receive user inputs via one or more input systems using, for example, the computing device 104 to input text, audio, and/or interact with an interactive user interface displayed on one or more output systems of, for example, the computing device 104. The processing system 102, the computing device 104, the one or more sensors 106, and the one or more databases 110 are configured to interact with one another via a network(s) 112. In an implementation, the sensor data is received directly from the one or more sensors 106 via a wired or wireless connection. As illustrated in greater detail below, any and/or all of the processing system 102, the computing device 104, and the one or more databases 110 may, in some instances, be special-purpose computing devices configured to perform specific functions.

The processing system 102 includes one or more computing devices (e.g., servers, routers, user interface devices, internet telephony computing device, and the like) that store and/or retrieve data in the one or more databases 110, generate user interfaces, execute input data system 114, a well data estimation system 116, an output data generation system 122, etc. by processing instructions. The processing system 102 may include a communication interface(s) 118 that is able to communicate with the one or more input systems and one or more output systems via the network(s) 112. For instance, the communication interface(s) 118 may be a network interface configured to support communication between the processing system 102 and the network(s) 112. The one or more input systems and one or more output systems may be part of the computing device 104 or separate from the computing device 104. The processing system 102 can be configured to train and maintain a machine learning model 120 to execute the techniques, as discussed in greater detail below. The processing system 102 can be configured to monitor and store (e.g., with appropriate permissions) sensor data for further analysis and/or training of the machine learning model 120. In an implementation, the processing system 102 is configured to transmit the communication to another computing device or database, such as the one or more databases 110. In an implementation, the processing system 102 is associated with an organization or entity.

In an implementation, the computing device 104 includes one or more input systems and one or more output systems. For instance, the operator is able to input user data to the processing system 102 via one or more interactive user interfaces using the computing device 104. The computing device 104 can be a smartphone, a tablet, a desktop computer, a laptop computer, or other personal computing device that may be used by an individual (e.g., the operator) to receive notification(s) and enter data. In some instances, the computing device 104 may be used to display plots, analytical information, notifications and/or other alerts using graphical user interfaces.

In an implementation, the processing system 102 includes instructions that direct and/or cause the well data estimation system 116 to execute processing techniques on the sensor data to generate input data subsets that are input into the machine learning model 120. In an implementation, the sensor data includes a pressure and a flow rate, such as, for example, a wellhead pressure and an injection rate or a slurry injection rate. In an implementation, the sensor data is stored in the one or more databases 110.

In an implementation, at least a portion of the sensor data is obtained by one or more sensors 106 disposed in a well or at a surface during well tests or reservoir tests. For instance, the pressure and flow rate are continuously monitored throughout a stimulation process or a step-down test. Step-down tests can be done early in the treatment during pad-fluid injection or at the end of the treatment during an overflush event, i.e., when the wellbore is free of proppant. A first part of the step-down process is establishing a stable surface treating pressure (STP) at the maximum injection rate, as per design or by treating pressure limitations. Then, the injection rate is decreased in three or more steps, each time establishing a stable pressure before advancing to the next step. Step-down tests culminate with termination of injection (i.e., shut-in) for obtaining an instantaneous shut-in pressure (ISIP), which is representative of the average bottomhole fracturing pressure (BHFP) among intervals or clusters). Pressures and rates are then evaluated in a history matching process using a machine learning model 120 trained using Bernoulli and tortuosity equations to generate the modeled pressure data. The fundamental treating pressure relationships are as follows:

$$STP = BHFP - HH + {P}_{p i p e} + {P}_{N W F} , \qquad ( 1 )$$

$$ISIP = BHFP - HH , \qquad ( 2 )$$

$$BHTP = BHFP + {P}_{N W F} , \qquad ( 3 )$$

$${P}_{N W F} = STP - ISIP - {P}_{p i p e} , \qquad ( 4 )$$

$${P}_{N W F} = {P}_{p e r f} + {P}_{tort} , \qquad ( 5 )$$

where STP=surface treating pressure, psi; BHFP=bottomhole fracturing pressure (within the hydraulic fractures at their intersection with the wellbore), psi; BHTP=bottomhole treating pressure (within casing, at the perforation entrance), psi; HH=hydrostatic head of the wellbore fluid/slurry column, psi; Pₚᵢₚₑ=pipe friction pressure, psi; P_{NWF}=near-wellbore friction pressure, psi; ISIP=instantaneous shut-in pressure at surface, psi; P_{perf}=perforation entry hole friction pressure, psi; Pₜₒᵣₜ=friction pressure due to near-wellbore tortuosity, psi,
where Modeled P_{perf} is derived from the Bernoulli theorem as stated in Eq. 6:

$${P}_{p e r f} = \sqrt{\frac{0.2369 \times {Q}^{2} \times ρ}{{C}_{d}^{2} \times {N}^{2} \times {D}^{4}}} , \qquad ( 6 )$$

where Q=injection rate, bbl/min; ρ (rho)=fluid/slurry density, lb/gal; C_{d}=discharge coefficient; N=number of perforations; D=perforation entry-hole diameter in casing, in.
Modeled friction pressure due to near wellbore tortuosity (Pₜₒᵣₜ) is derived from Eq. 7:

$${P}_{tort} = B \times {Q}^{t - exp} , \qquad ( 7 )$$

where B (beta)=dimensionless adjustment parameter used for achieving the best model fit; Q=injection rate, bbl/min; and t-exp=injection-rate exponent, ranging from 0.25 to 1.

In an implementation, the machine learning model 120 is trained to generate one or more estimated key performance indicators, such as, for example, near wellbore friction (NWBF) based on the input data, such as, for example, pressure and flow rate data. In an implementation, the machine learning model 120 utilizes a random decision forest machine learning algorithm. In an implementation, the sensor data is received from a pressure sensor and a flow rate sensor. The machine learning model 120 may be built from historical data that has been previously collected and stored, for example, at the one or more databases 110. In this implementation, the machine learning model 120 leverages the historical data to generate the one or more estimated key performance indicators. In an implementation, the machine learning model 120 allows the well data estimation system 116 to generate one or more estimated key performance indicators based on the input data and the historical data. The historical data can be received from the one or more databases 110. Accordingly, the machine learning model 120 allows the well data estimation system 116 to generate one or more estimated key performance indicators, such as, for example, near wellbore friction (NWBF), in real-time to allow for analysis of an oil or gas production system to assist in optimization decisions, such as, for example, treatment parameters, restimulations, recompletions, and/or redrills using a large volume of data involving a large number of production systems, despite only having sensor data relating to pressure and flow rate, such as, for example, wellhead pressure and injection flow rate or slurry injection flow rate.

In an implementation, the processing system 102 includes instructions that direct and/or cause the well data estimation system 116 to generate near wellbore friction (NWBF) data using the sensor data. In an implementation, the sensor data includes a measured flow rate and a wellhead pressure. In an implementation the sensor data is received from the one or more sensors 106, such as, for example, a flow rate sensor and a pressure sensor. In an implementation, the processing system 102 includes instructions that direct and/or cause the well data estimation system 116 to automatically generate analysis data based on the one or more generated key performance indicators, such as, for example, near wellbore friction (NWBF) for each perforation cluster within a stage. The analysis includes determining well parameters, such as, fluid velocity, pressure drop for plain water, pressure drop for a given gel and proppant concentration, pipe friction, perforation entry hole friction, and/or near wellbore tortuosity friction using equations 1-8

$$v = \frac{17.156 \times Q}{{d}^{2}} \qquad ( 1 )$$

$$Δ {P}_{O} = ( \frac{L \times p \times {v}^{2}}{557.4 \times d \times {( \frac{928 \times d \times v \times p}{μ} )}^{- 0.2}} ) , Q > 0 \qquad ( 2 )$$

$$Δ {P}_{G , P} = Δ {P}_{O} \times m \times {( e ( 2.38 - \frac{8.024}{v} - \frac{0.2365 \times G}{v} - ( 0.1639 \times ln ( G ) ) - ( 0.028 \times P \times {e}^{( 1 / G )} ) ) )}^{- 1} , Q > 0 \qquad ( 3 )$$

$${P}_{p i p e} = {\sum }_{C = 0}^{i} Δ {P}_{G , P} \qquad ( 4 )$$

$$NWB {F}_{M} = {P}_{W} - {P}_{p i p e} - ISI \qquad ( 5 )$$

$${P}_{p e r f} = 0.237 \times ρ \times {( \frac{Q}{N \times {C}_{p} \times {D}_{p}^{2}} )}^{2} \qquad ( 6 )$$

$${P}_{tort} = β \times {Q}^{t} \qquad ( 7 )$$

$$NWB {F}_{E} = {P}_{p e r f} + {P}_{tort} \qquad ( 8 )$$

where:
C=An individual casing component (0 through i)
ΔP_{G,P}=Pressure drop for a given gel and proppant concentration
Pₚᵢₚₑ=Pipe friction (psi)
P_{perf}=Perforation entry hole friction (psi)
Pₜₒᵣₜ=Near wellbore tortuosity friction (psi)
P_{W}=Wellhead pressure (psi), i.e., treatment pressure
ISIP=Instantaneous shut-in pressure (psi)
NWBF_{M}=Measured near wellbore friction (psi)
NWBF_{E}=Estimated near wellbore friction (psi)
Q=Flow rate (BBLs/min)
ρ=Water density (lbs/gal)
N=Number of perforations
Cₚ=Perforation discharge coefficient
D_{P}=Perforation diameter (in)
β=Tortuosity coefficient
t=Tortuosity coefficient
L=Length of pipe (ft)
d=Internal diameter of pipe (in)
ν=Fluid velocity (ft/sec)
G=Equivalent gel concentration (lbs/Mgal)
P=proppant concentration (lbs/gal)
μ=Water viscosity (lbs/gal)
ΔPₒ=Pressure drop for plain water (psi)
m=Fluid friction multiplier
In an implementation, the processing system 102 includes instructions that direct and/or cause the output data generation system 122 to perform one or more of the functions described herein. For example, the output data generation system 122 is configured to generate a notification regarding the one or more key performance indicators. For instance, the notification is audio, visual, and/or textual notification. In an implementation, the notification indicates a plot of analyzed data using the one or more key performance indicators for one or more production systems. In an implementation, the notification may be sent upon request and/or periodically to the computing device 104, such as, for example, a report in an e-mail. For instance, the notification may be sent, hourly, daily, weekly, monthly, etc. In another implementation, the notification indicates that one or more production systems require action. In an implementation, the notification is presented via one or more interactive user interfaces generated by the output data generation system 122 and transmitted, via the communication interface(s) 118, to the computing device 104 for display by the output system of the computing device 104.

The network(s) 112 can be any combination of one or more of a cellular network such as a 3rd Generation Partnership Project (3GPP) network, a third generation (3G) network, a fourth generation (4G) network, a fifth generation (5G) network, a Long-Term Evolution (LTE), an LTE Advanced Network, a Global System for Mobile Communications (GSM) network, a Universal Mobile Telecommunications System (UMTS) network, and the like. Moreover, the network(s) 112 can include any type of network, such as the Internet, an intranet, a Virtual Private Network (VPN), a Voice over Internet Protocol (VOIP) network, a wireless network (e.g., Bluetooth), a cellular network, a satellite network, combinations thereof, etc. The network(s) 112 can include communications network components such as, but not limited to gateways routers, servers, and registrars, which enable communication across the network(s) 112. In one implementation, the communications network components include multiple ingress/egress routers, which may have one or more ports, in communication with the network(s) 112.

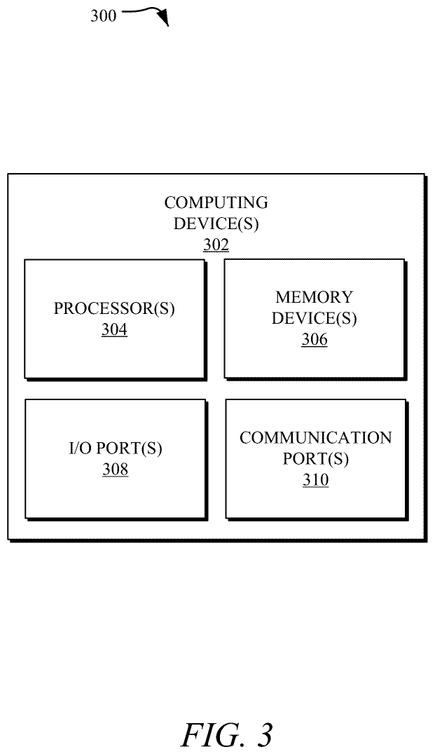

Turning to FIG. 3, a system 300 to process communication data can include one or more computing devices 302 for performing the techniques discussed herein. In one implementation, the one or more computing devices 302 include the computing device 104 and/or one or more servers of the processing system 102 to generate and execute the input data system 114, the well data estimation system 116, output data generation system 122, etc. as a software application and/or a module or algorithmic component of software.

In some instances, the computing device 302 can include a computer, a personal computer, a desktop computer, a laptop computer, a terminal, a workstation, a server device, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. The computing device 302 may be integrated with, form a part of, or otherwise be associated with the systems 100-300. It will be appreciated that specific implementations of these devices may be of differing possible specific computing architectures not all of which are specifically discussed herein but will be understood by those of ordinary skill in the art.

The computing device 302 may be a computing system capable of executing a computer program product to execute a computer process. Data and program files may be input to the computing device 302, which reads the files and executes the programs therein. Some of the elements of the computing device 302 include one or more processors 304, one or more memory devices 306, and/or one or more ports, such as input/output (IO) port(s) 308 and communication port(s) 310. Additionally, other elements that will be recognized by those skilled in the art may be included in the computing device 302 but are not explicitly depicted in FIG. 3 or discussed further herein. Various elements of the computing device 302 may communicate with one another by way of the communication port(s) 310 and/or one or more communication buses, point-to-point communication paths, or other communication means.

The processor 304 may include, for example, a central processing unit (CPU), a microprocessor, a microcontroller, a digital signal processor (DSP), and/or one or more internal levels of cache. There may be one or more processors 304, such that the processor 304 comprises a single central-processing unit, or a plurality of processing units capable of executing instructions and performing operations in parallel with each other, commonly referred to as a parallel processing environment.

The computing device 302 may be a conventional computer, a distributed computer, or any other type of computer, such as one or more external computers made available via a cloud computing architecture. The presently described technology is optionally implemented in software stored on the data storage device(s) such as the memory device(s) 306, and/or communicated via one or more of the I/O port(s) 308 and the communication port(s) 310, thereby transforming the computing device 302 in FIG. 3 to a special purpose machine for implementing the operations described herein. Moreover, the computing device 302, as implemented in the systems 100-300, receives various types of input data (e.g., the sensor data) and transforms the sensor data through various stages of the data flow into new types of data files (e.g., one or more estimated key performance indicators data). Moreover, these new data files are transformed further into output data and sent to the computing device 104 to provide information regarding the data, which enables the computing device 302 to do something it could not do before-using a machine learning model to generate near wellbore friction data from pressure and flow rate data monitored during a stimulation process or step-down test.

Additionally, the systems and operations disclosed herein represent an improvement to the technical field of machine learning processing. For instance, the processing system 102 can generate one or more key performance indicators with vast amounts of data from a plurality of production systems without human intervention. Moreover, data can be leveraged provide a highly efficient and effective productivity analysis of a large number or oil and gas production systems. These techniques are rooted in technology and could not have existed prior to the advent of machine learning analytics.

The one or more memory device(s) 306 may include any non-volatile data storage device capable of storing data generated or employed within the computing device 302, such as computer executable instructions for performing a computer process, which may include instructions of both application programs and an operating system (OS) that manages the various components of the computing device 302. The memory device(s) 306 may include, without limitation, magnetic disk drives, optical disk drives, solid state drives (SSDs), flash drives, and the like. The memory device(s) 306 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 306 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 306 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 302 includes one or more ports, such as the I/O port(s) 308 and the communication port(s) 310, for communicating with other computing, network, or vehicle computing devices. It will be appreciated that the I/O port 308 and the communication port 310 may be combined or separate and that more or fewer ports may be included in the computing device 302.

The I/O port 308 may be connected to an I/O device, or other device, by which information is input to or output from the computing device 302. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 302 via the I/O port 308. Similarly, the output devices may convert electrical signals received from the computing device 302 via the I/O port 308 into signals that may be sensed as output by a human, such as sound, light, and/or touch. The input device may be an alphanumeric input device, including alphanumeric and other keys for communicating information and/or command selections to the processor 304 via the I/O port 308. The input device may be another type of user input device including, but not limited to direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing device 302 via the I/O port 308. For example, an electrical signal generated within the computing device 302 may be converted to another type of signal, and/or vice-versa. In one implementation, the environment transducer devices sense characteristics or aspects of an environment local to or remote from the computing device 302, such as, light, sound, temperature, pressure, magnetic field, electric field, chemical properties, physical movement, orientation, acceleration, gravity, and/or the like.

In one implementation, the communication port 310 is connected to the network(s) 112 so the computing device 302 can receive network data useful in executing the methods and systems set out herein as well as transmitting information and network configuration changes determined thereby. Stated differently, the communication port 310 connects the computing device 302 to one or more communication interface devices configured to transmit and/or receive information between the computing device 302 and other devices by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 310 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 310 may communicate with an antenna or other link for electromagnetic signal transmission and/or reception.

In an example, the processing system 102, the input data system 114, the well data estimation system 116, the output data generation system 122, etc., and/or other software, modules, services, and operations discussed herein may be embodied by instructions stored on the memory device(s) 306 and executed by the processor 304.

The system set forth in FIG. 3 is but one possible example of a computing device 302 or computer system that may be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 302.

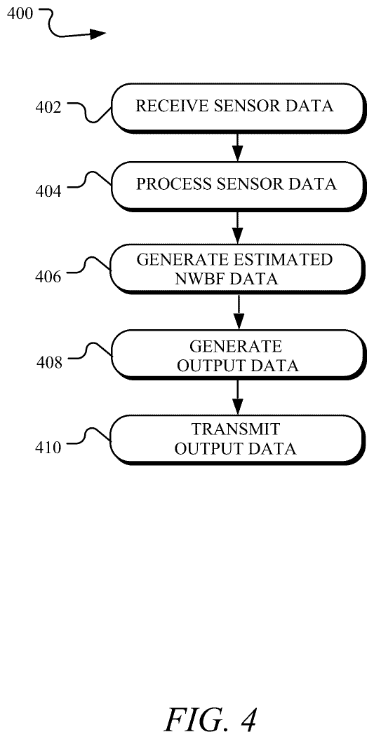

FIG. 4 depicts an example method 400 for optimizing natural resource production systems, which can be performed by any of the systems 100-300 discussed herein. The method 400 can, in some instances, occur in real time.

At operation 402, the method 400 can receive sensor data via the communication interface(s) 118 from the one or more sensors 106. In an implementation, the sensor data includes a well head pressure and a flow rate.

At operation 404, the method 400 can process the sensor data for input into the machine learning model 120. In an implementation, the processing includes one or more of cleaning/filtering the sensor data and generating one or more input data sets for the machine learning model 120.

At operation 406, the method 400 can generate estimated near wellbore friction (NWBF) data based on the sensor data using the machine learning model 120. For instance, the NWBF may be determined for each perforation cluster after each stage in a step-down test.

At operation 408, the method 400 can output data using the output data generation system. For instance, the output system can generate a user interface indicating a plot of the NWBF data. For instance, the pressure and flow rate after each stage in a step-down test can be used to determining the NWBF data and plot the results. In an implementation, a data point outside of a threshold expected value can be rejected and not displayed on the plot. In an implementation, the output data includes optimizing the production system, such as, for example, treatment parameters, restimulations, recompletions, and/or redrills based on the NWBF data.

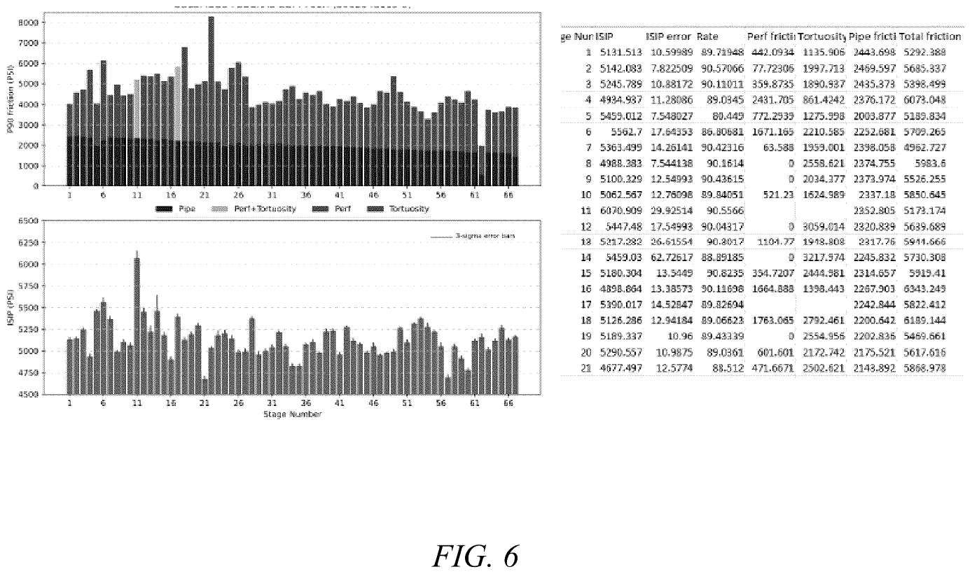

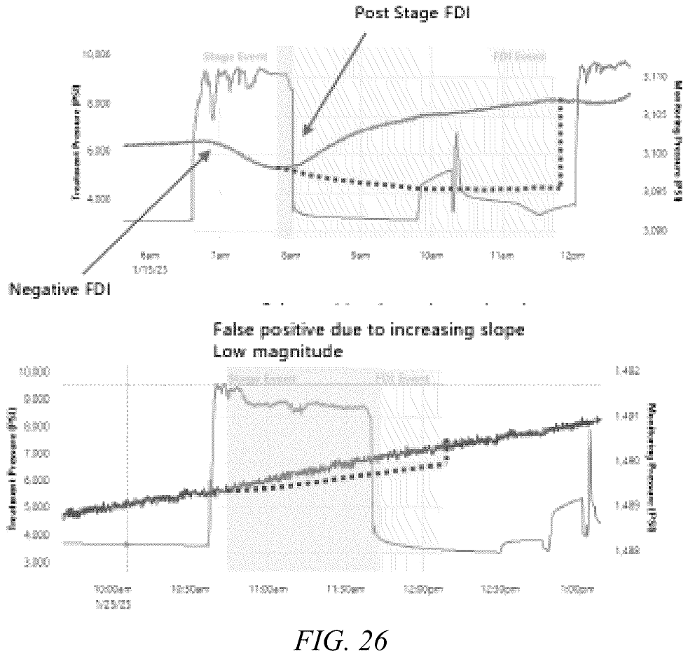

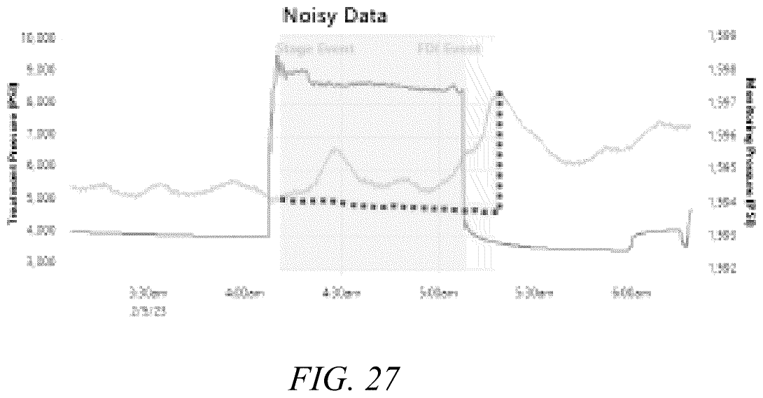

At operation 410, the method 400 can transmit the output data to the computing device 104. In an implementation, the output data can be output via the computing device 104, such as, for example, via a graphical user interface. In an implementation, the output data controls the production system to optimize the system. In an implementation, the output data includes one or more of the graphical representations illustrated in FIGS. 6-31.

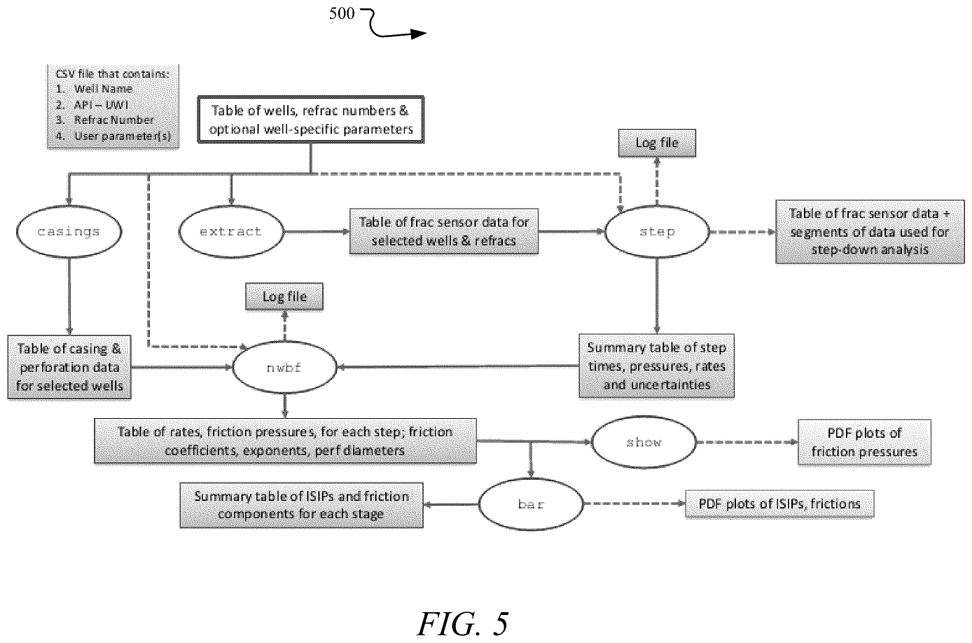

FIG. 5 depicts an example method 500 for generating graphical representations, which can be performed by any of the systems 100-300 discussed herein. The method 500 can, in some instances, occur in real time. For instance, one or more of the graphical representations illustrated in FIGS. 6-31 may be generated using method 500.

It is to be understood that the specific order or hierarchy of operations in the methods depicted in FIG. 4, FIG. 5, and throughout this disclosure are instances of example approaches and can be rearranged while remaining within the disclosed subject matter. For instance, any of the operations depicted in FIG. 4 and FIG. 5 may be omitted, repeated, performed in parallel, performed in a different order, and/or combined with any other of the operations depicted in FIG. 4, FIG. 5, or discussed herein.

FIG. 6 illustrates a graphical representation of plots of output data generated by the various systems and methods discussed herein for a plurality of stages. In an implementation, the plots of FIG. 6 can be displayed via the computing device 104, such as, for example, via a graphical user interface.

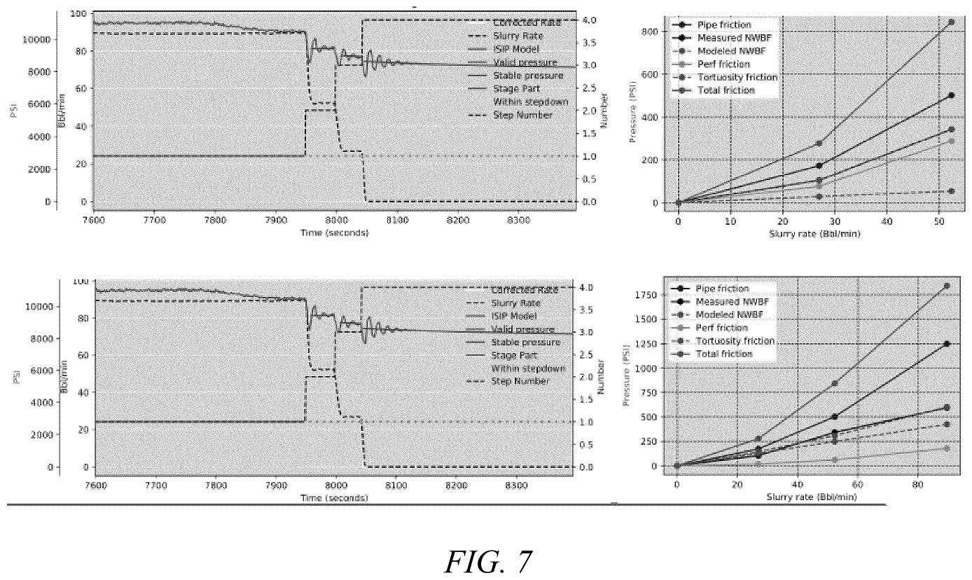

FIG. 7 illustrates a graphical representation of plots of pressure data generated by the various systems and methods discussed herein for a particular stage. In an implementation, the plots of FIG. 7 can be displayed via the computing device 104, such as, for example, via a graphical user interface.

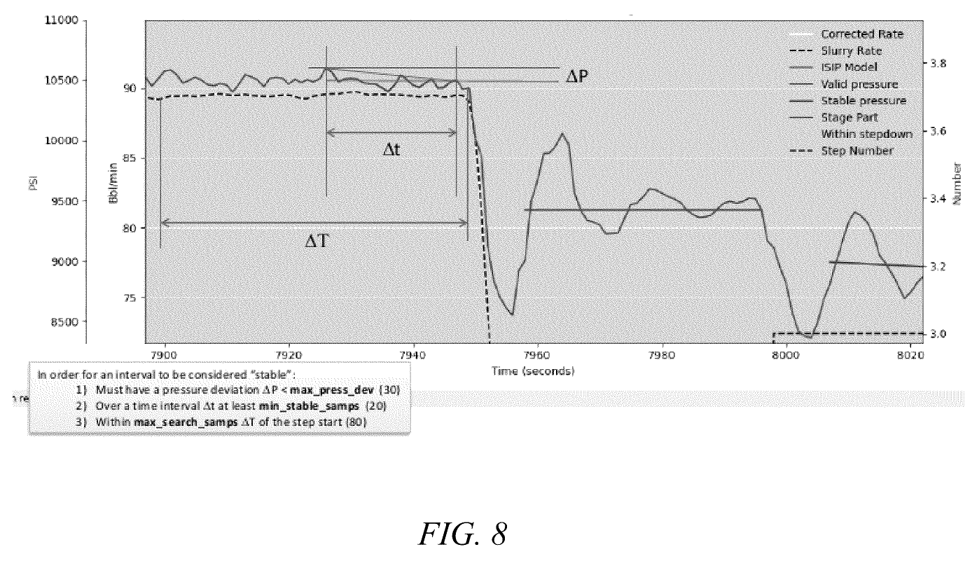

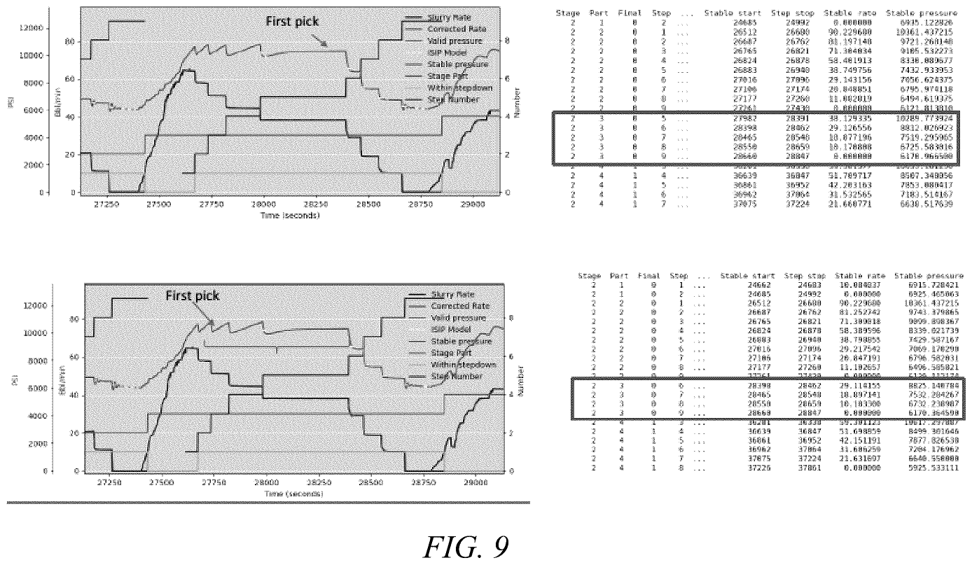

FIGS. 8 and 9 illustrate a graphical representation of a plot of pressure over time generated by the various systems and methods discussed herein for a particular stage. The plot shown in FIGS. 8 and 9 allow for determining the stability for an interval. In an implementation, the plots of FIGS. 8 and 9 can be displayed via the computing device 104, such as, for example, via a graphical user interface.

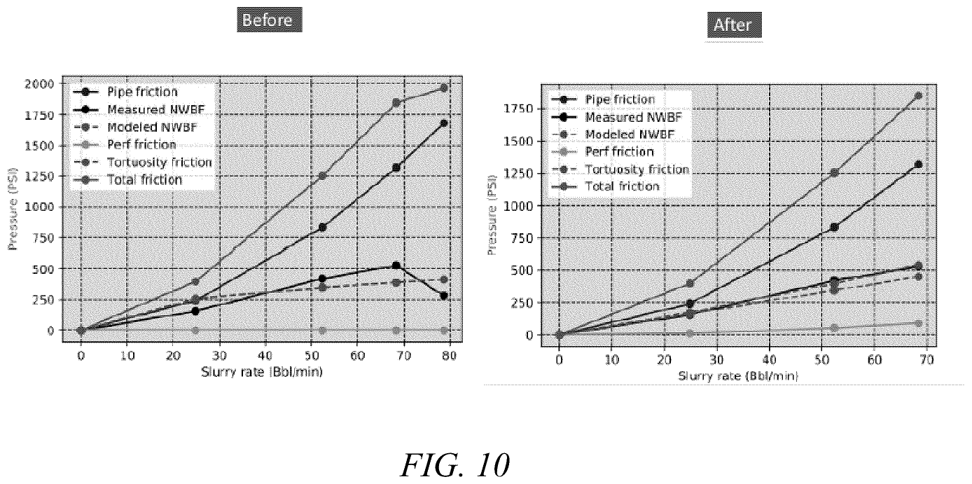

FIG. 10 illustrates a graphical representation of a plot resulting from the rejection of a data point that is outside a threshold. In an implementation, the resulting plot of FIG. 10 can be displayed via the computing device 104, such as, for example, via a graphical user interface.

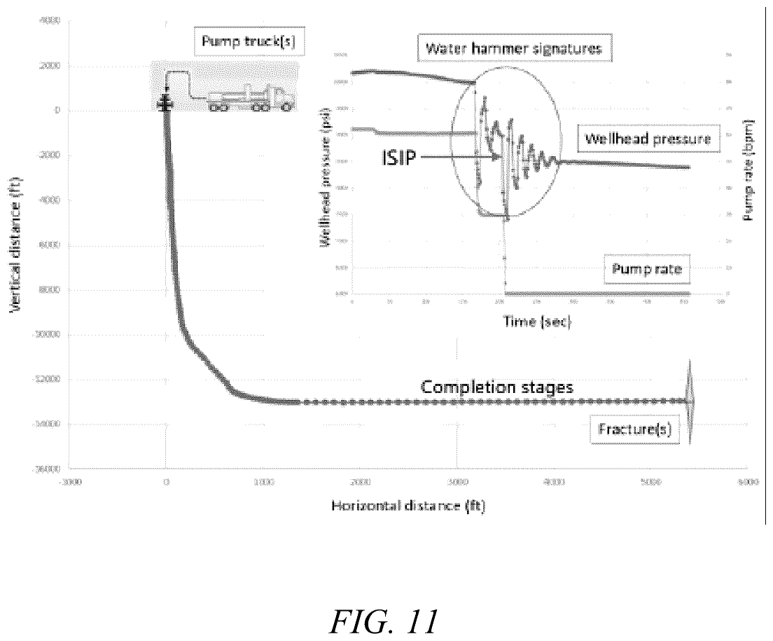

FIG. 11 illustrates a graphical representation of a plot of end of stage pressure diagnostics. The plot can be generated by the various systems and methods discussed herein. The plot illustrates at least one of water hammer signatures, wellhead pressure, or pressure drops between rate steps. In an implementation, the plot of FIG. 11 can be displayed via the computing device 104, such as, for example, via a graphical user interface.

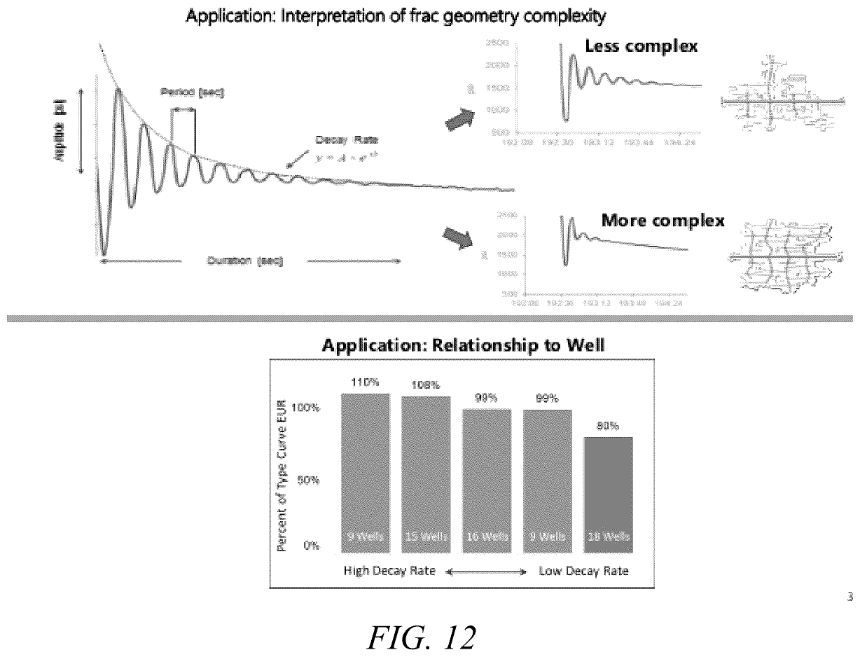

FIG. 12 illustrates graphical representations of water hammer analysis. The plots can be generated by the various systems and methods discussed herein. The plots illustrate at least one of frac geometry complexity or relationship to well production using a pressure signal measured at the end of a frac stage. In an implementation, the plots of FIG. 12 can be displayed via the computing device 104, such as, for example, via a graphical user interface.

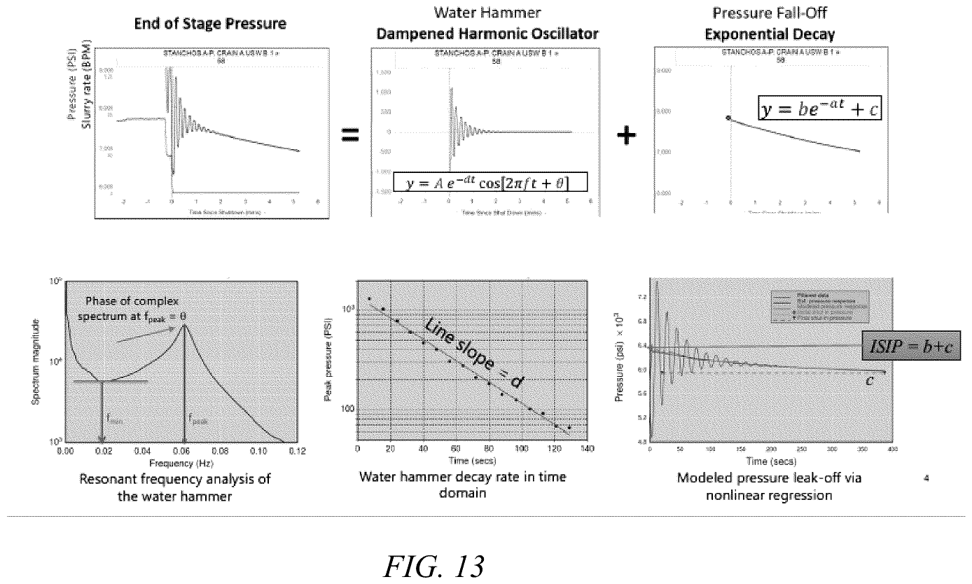

FIG. 13 illustrates graphical representations of ISIP analysis. The plots can be generated by the various systems and methods discussed herein using signal processing. The plots illustrate estimated parameters including at least one of end of stage pressure, water hammer dampened harmonic oscillator, exponential pressure decay, resonant frequency analysis of the water hammer, water hammer decay rate, or pressure leak-off. In an implementation, the plots of FIG. 13 can be displayed via the computing device 104, such as, for example, via a graphical user interface.

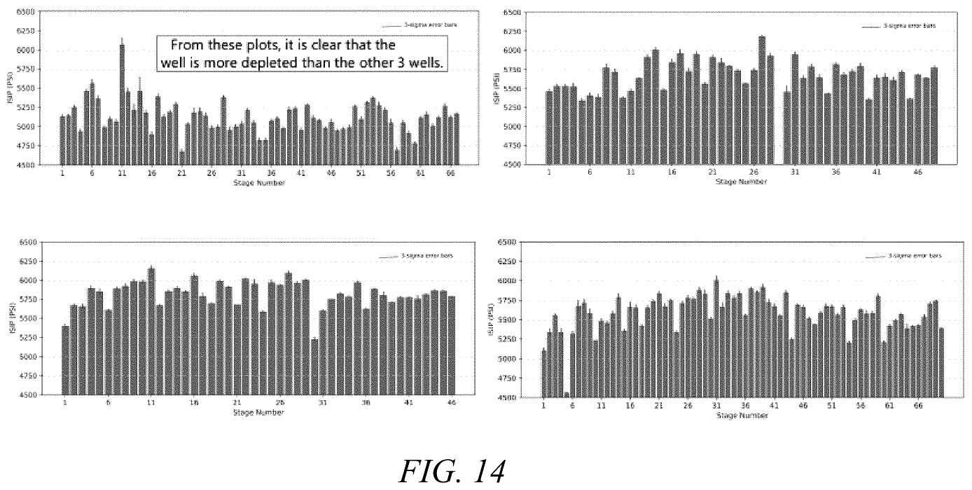

FIG. 14 illustrates graphical representations of ISIP of various wells. The plots can be generated by the various systems and methods discussed herein. The plots illustrate ISIP to allow for comparison of depletion levels of the wells. In an implementation, the plots of FIG. 14 can be displayed via the computing device 104, such as, for example, via a graphical user interface.

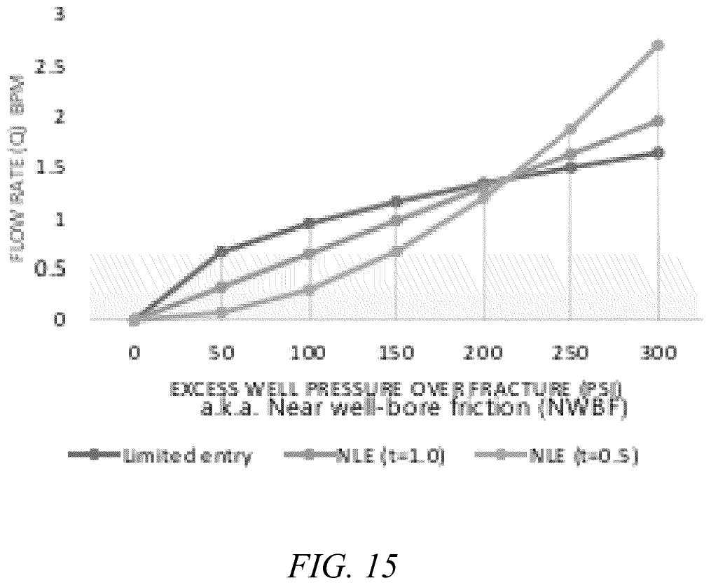

FIG. 15 illustrates a graphical representation of near well-bore friction (NWBF). The plots can be generated by the various systems and methods discussed herein. The plots illustrate NWBF for limited entry design versus non-limited entry design. In an implementation, the plot of FIG. 15 can be displayed via the computing device 104, such as, for example, via a graphical user interface.

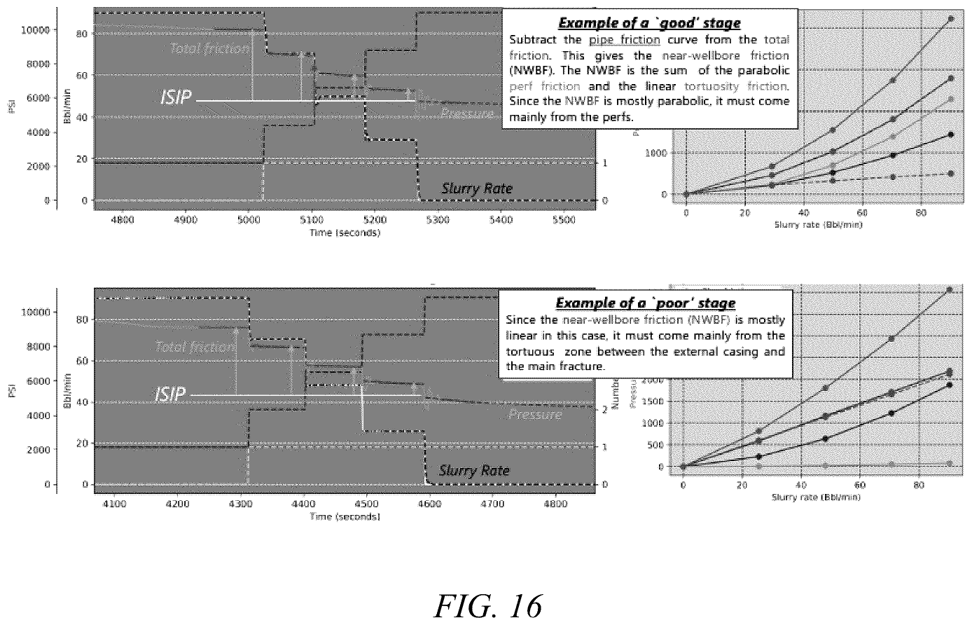

FIG. 16 illustrates graphical representations of step-down analysis. The plots can be generated by the various systems and methods discussed herein. The plots illustrate pressure over time to allow for comparison of step-down stages of a well. In an implementation, the plots of FIG. 16 can be displayed via the computing device 104, such as, for example, via a graphical user interface.

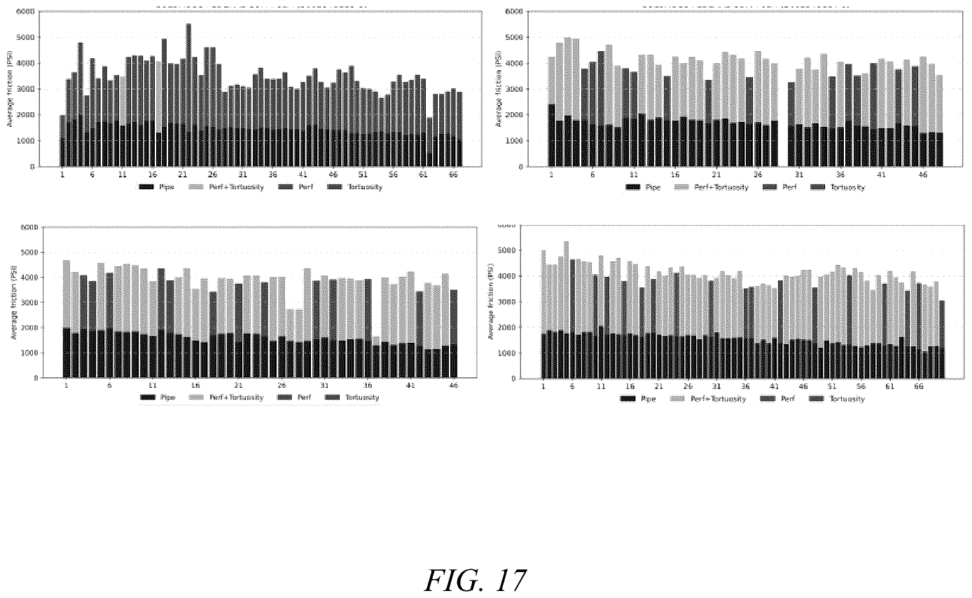

FIG. 17 illustrates graphical representations of average friction for a plurality of stages for a well. The plots can be generated by the various systems and methods discussed herein. The plots allow for friction breakdowns for a plurality of stages for a plurality of wells. In an implementation, the plots of FIG. 17 can be displayed via the computing device 104, such as, for example, via a graphical user interface.

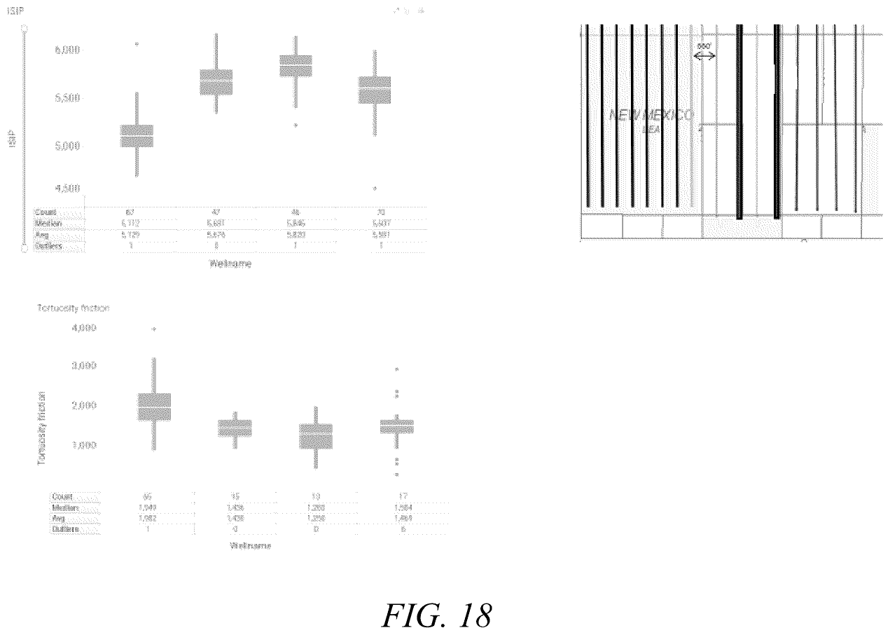

FIG. 18 illustrates graphical representations of ISIP perf frictions and tortuosity frictions for a plurality of wells. The plots can be generated by the various systems and methods discussed herein. The plots allow for a comparison of depletion and performance for a plurality of wells. In an implementation, the plots of FIG. 18 can be displayed via the computing device 104, such as, for example, via a graphical user interface.

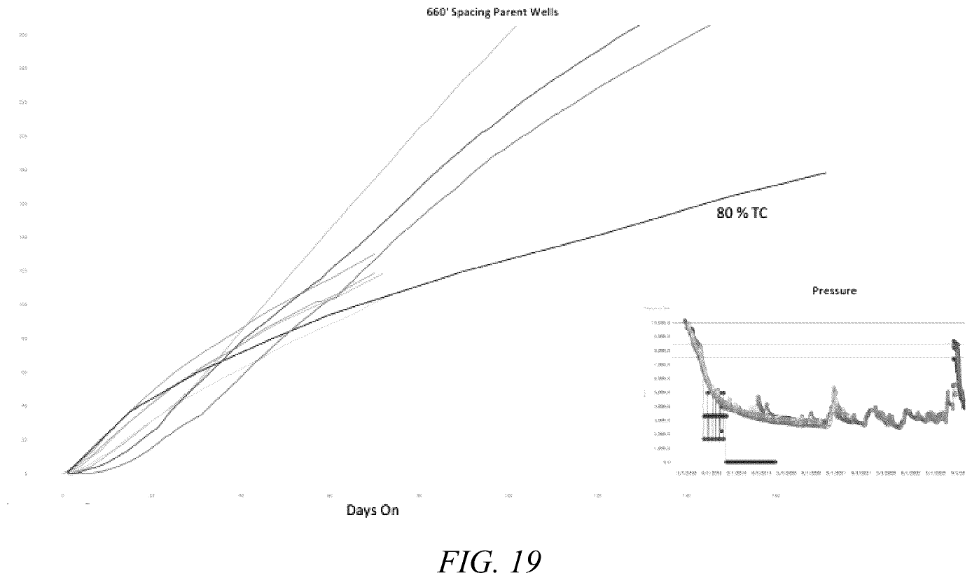

FIG. 19 illustrates a graphical representation of well performance for a plurality of wells. The plots can be generated by the various systems and methods discussed herein. The plots allow for a comparison of performance for a plurality of wells. In an implementation, the plots of FIG. 19 can be displayed via the computing device 104, such as, for example, via a graphical user interface.

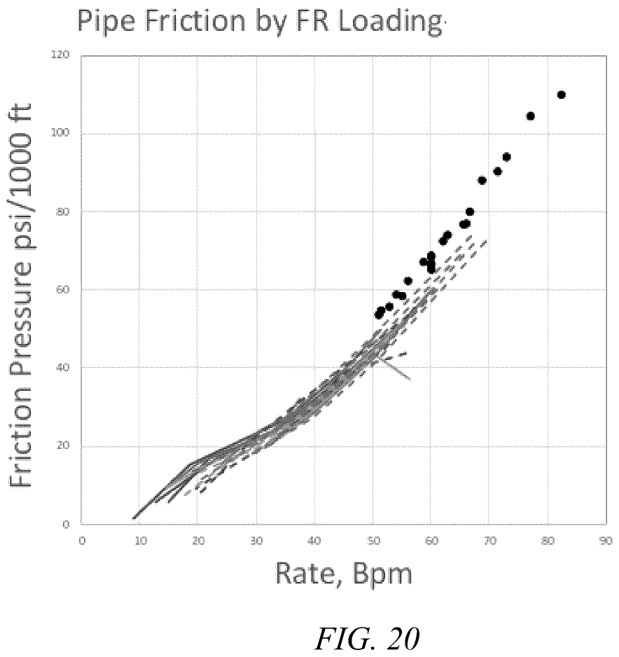

FIG. 20 illustrates a graphical representation of pipe friction during remote frac tests. The plots can be generated by the various systems and methods discussed herein. In an implementation, the plot of FIG. 20 can be displayed via the computing device 104, such as, for example, via a graphical user interface.

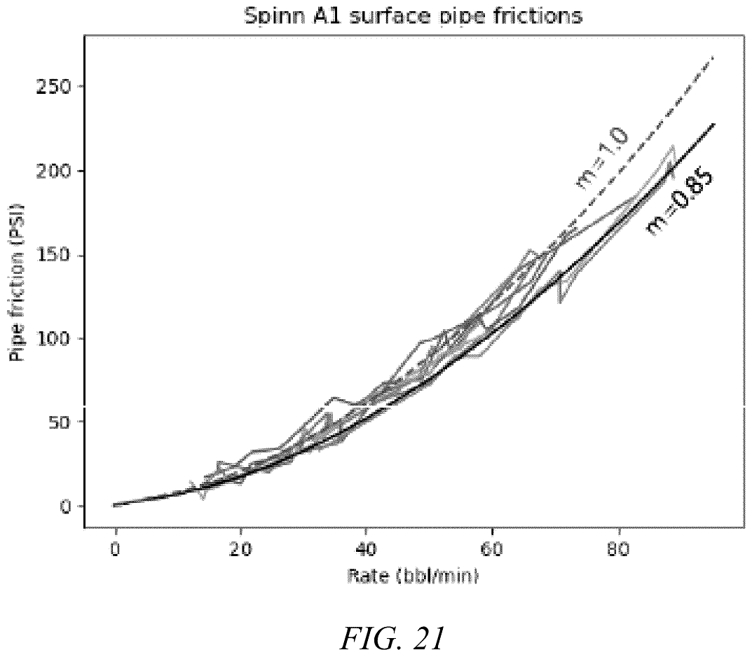

FIG. 21 illustrates a graphical representation of surface pipe frictions. The plots can be generated by the various systems and methods discussed herein. The plot allows for a comparison of surface pipe frictions with a Lord McGowen formulation, where m is the friction multiplier. In an implementation, the plot of FIG. 21 can be displayed via the computing device 104, such as, for example, via a graphical user interface.

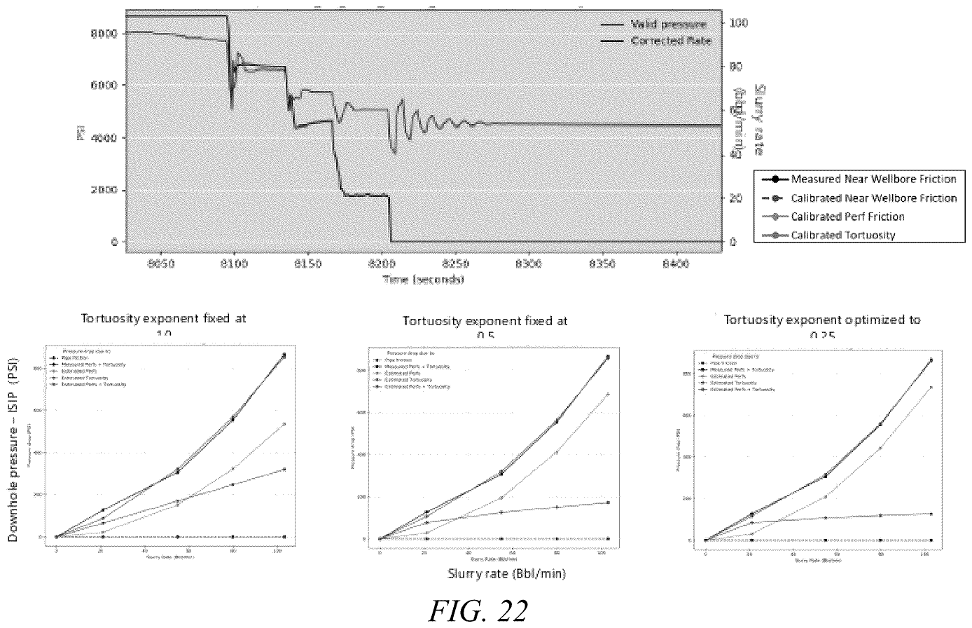

FIG. 22 illustrates graphical representations of step-down inversion of well data. The plots can be generated by the various systems and methods discussed herein. The plots allow for a comparison of downhole pressure at various tortuosity exponents. In an implementation, the plots of FIG. 22 can be displayed via the computing device 104, such as, for example, via a graphical user interface.

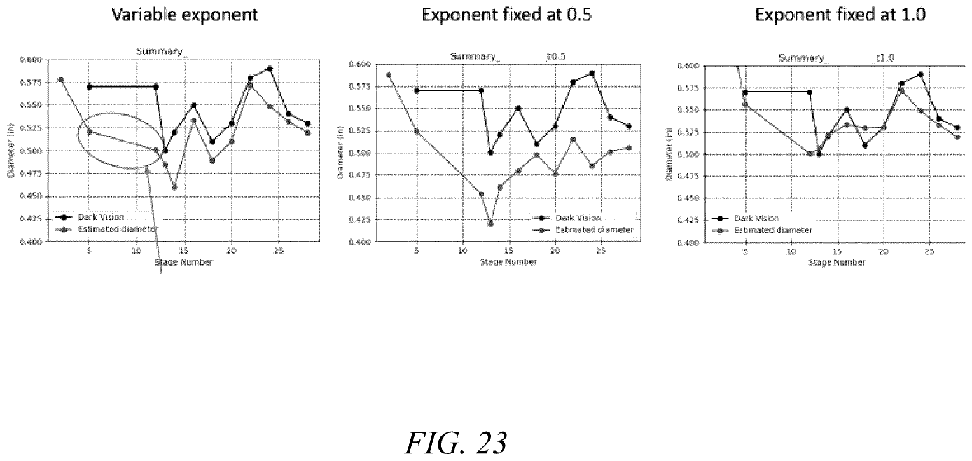

FIG. 23 illustrates graphical representations of estimated diameters for a plurality of stages. The plots can be generated by the various systems and methods discussed herein. The plots allow for a comparison of estimated diameters at various exponents. In an implementation, the plots of FIG. 23 can be displayed via the computing device 104, such as, for example, via a graphical user interface.

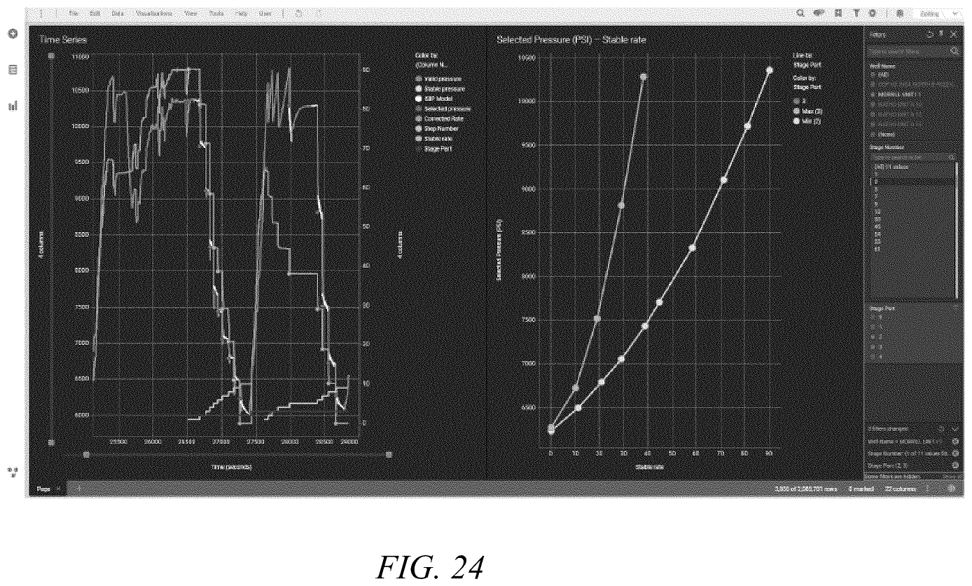

FIG. 24 illustrates graphical representations of results of step-down tests. The plots can be generated by the various systems and methods discussed herein. The plots allow for a comparison of friction reduction. In an implementation, the plots of FIG. 24 can be displayed via the computing device 104, such as, for example, via a graphical user interface.

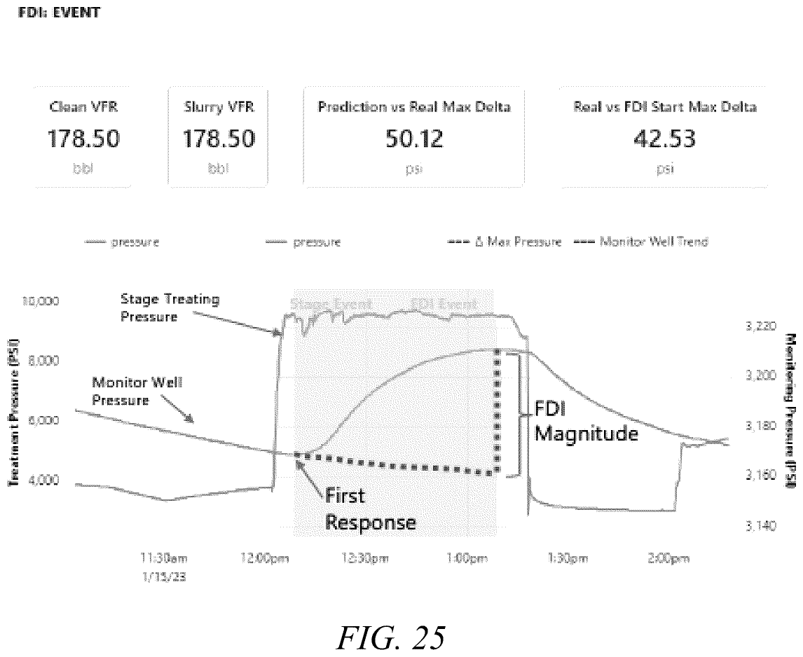

FIGS. 25-27 illustrate a graphical representation of fracture-driven interactions. The plots can be generated by the various systems and methods discussed herein. The plots allow for a projection pressure trend prior to a fracture-driven interaction, peak pressure and change from projection to peak pressure. In an implementation, the plots of FIGS. 25-27 can be displayed via the computing device 104, such as, for example, via a graphical user interface.

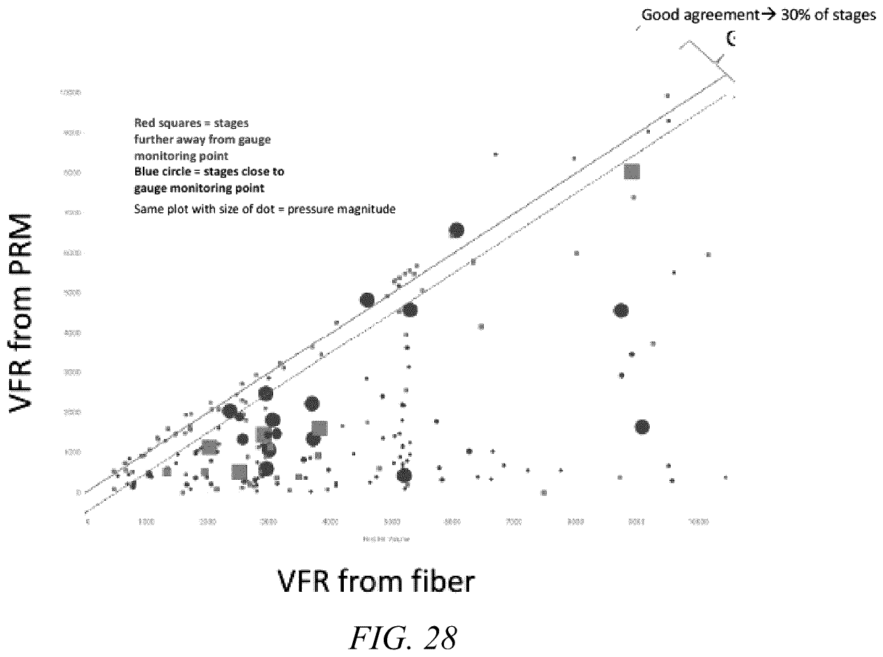

FIG. 28 illustrate a graphical representation of Volume to First Response (VFR) from Permanent Reservoir Monitoring (PRM) and from the wireline (WL) fiber. The plot allows for showing the agreement between the PRM and the fiber. In an implementation, the plot of FIG. 28 can be displayed via the computing device 104, such as, for example, via a graphical user interface.

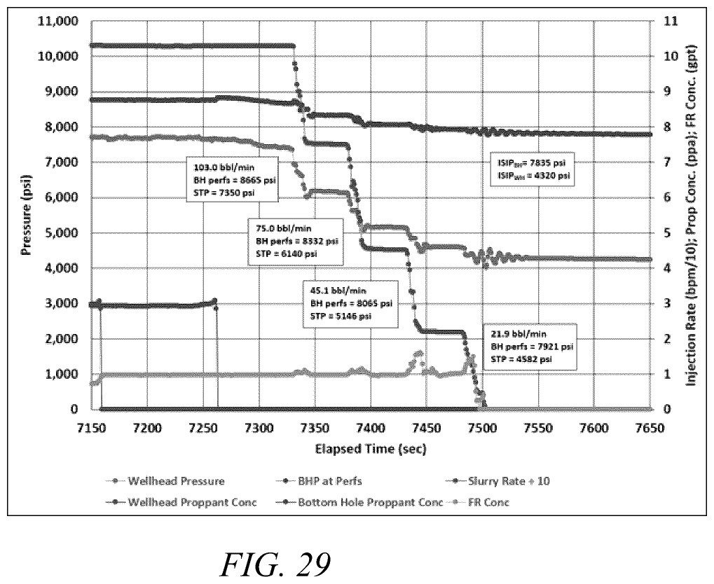

FIG. 29 illustrates a graphical representation of a plot of an end of job step down test analysis. The plot can be generated by the various systems and methods executing the machine learning model 120 discussed herein using the history matching process. In an implementation, the plot of FIG. 29 can be displayed via the computing device 104, such as, for example, via a graphical user interface.

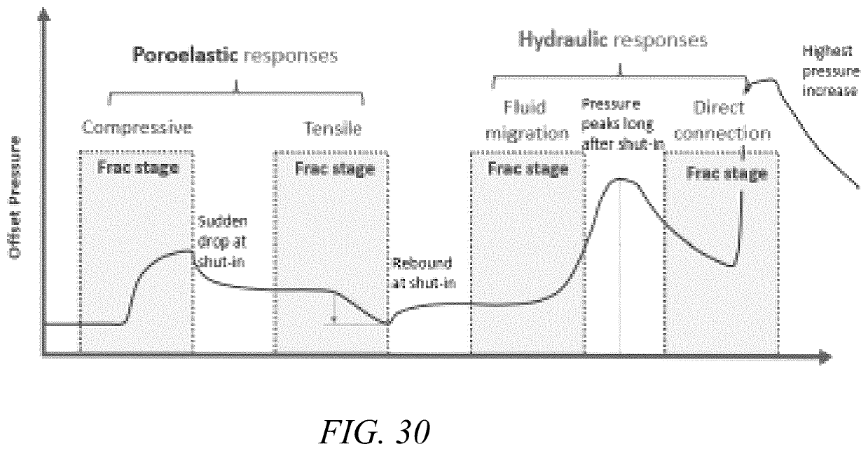

FIG. 30 illustrates a graphical representation of a plot of different types of fracture-driven interactions. The plot allows for showing real-time completion design changes based on different inputs. In an implementation, the plot of FIG. 30 can be displayed via the computing device 104, such as, for example, via a graphical user interface.

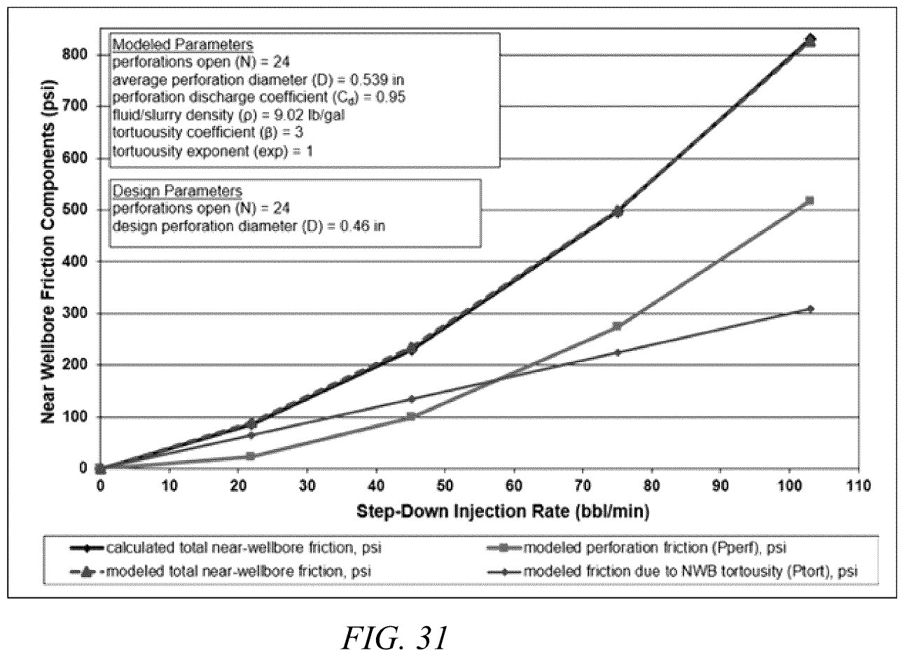

FIG. 31 illustrates a graphical representation of a parameter plot of a step-down test done at the end of a frac stage. The parameter plot can be generated by the various systems and methods discussed herein using at least one of equations (1) through (5). In an implementation, the parameter plot of FIG. 31 can be displayed via the computing device 104, such as, for example, via a graphical user interface.

The system and methods described herein facilitate decisions to optimize well performance through restimulations, recompletions, and redrills to maximize the producing potential of wells in more than one field. The generated dataset is also valuable in providing lessons learned from retrospective studies about historical completion and stimulation practices over the history of a field.

Furthermore, any term of degree such as, but not limited to, “substantially,” as used in the description and the appended claims, should be understood to include an exact, or a similar, but not exact configuration. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A system for optimizing a natural resource production system, the system comprising:
a processing system in communication with a computing device, one or more pressure sensors, one or more flow rate sensors, and one or more databases over a network, the computing device having one or more input systems and one or more output systems, the processing system configured to receive pressure data and flow rate data from the one or more pressure sensors and the one or more flow rate sensors; and
a well data estimation system having a machine learning model, the well data estimation system configured to generate estimated near wellbore friction data for the pressure data and the flow rate data by executing the machine learning model.

2. The system of claim 1 further comprising:
an output data generation system configured to generate a notification associated with the estimated near wellbore friction data, the processing system configured to transmit the notification to the computing device to cause the notification to be presented using the one or more output systems.

3. The system of claim 2, wherein the notification includes a plot of the estimated near wellbore friction data.

4. The system of claim 1, wherein the computing device includes at least one of a smartphone, a tablet, a desktop computer, a laptop computer, or a personal computing device.

5. The system of claim 1, wherein the pressure data includes a wellhead pressure, and the flow rate data includes a slurry injection rate.

6. The system of claim 1, wherein the well data estimation system determines one or more well parameters using the estimated near wellbore friction data.

7. The system of claim 6, wherein the one or more well parameters include at least one of fluid velocity, pressure drop for plain water, pressure drop for a given gel and proppant concentration, pipe friction, perforation entry hole friction, or near wellbore tortuosity friction.

8. A method for optimizing a natural resource production system, the method comprising:
receiving pressure data from one or more pressure sensors;
receiving flow rate data from one or more flow rate sensors;
generating estimated near wellbore friction data using the pressure data and the flow rate data be executing a machine learning model; and
generating output data using the estimated near wellbore friction data.

9. The method of claim 8, further comprising:
generating a notification associated with the estimated near wellbore friction data; and
transmitting the notification to a computing device to cause the notification to be presented using one or more output systems of a computing device.

10. The method of claim 9, wherein the notification includes a plot of the estimated near wellbore friction data.

11. The method of claim 9, wherein the computing device includes at least one of a smartphone, a tablet, a desktop computer, a laptop computer, or a personal computing device.

12. The method of claim 8, wherein the pressure data includes a wellhead pressure, and the flow rate data includes an injection rate.

13. The method of claim 8, further comprising:
determining one or more well parameters using the estimated near wellbore friction data.

14. The method of claim 13, wherein the one or more well parameters include at least one of fluid velocity, pressure drop for plain water, pressure drop for a given gel and proppant concentration, pipe friction, perforation entry hole friction, or near wellbore tortuosity friction.

15. One or more tangible non-transitory computer-readable storage media storing computer-executable instructions for performing a computer process on a computing system, the computer process comprising:
receive pressure data from one or more pressure sensors;
receive flow rate data from one or more flow rate sensors;
generate estimated near wellbore friction data using the pressure data and the flow rate data by executing a machine learning model; and
generate output data using the estimated near wellbore friction data.

16. The one or more tangible non-transitory computer-readable storage media storing computer-executable instructions for performing the computer process on the computing system of claim 15, the computer process further comprising:
generate a notification associated with the estimated near wellbore friction data; and
transmit the notification to a computing device to cause the notification to be presented using one or more output systems of the computing device.

17. The one or more tangible non-transitory computer-readable storage media storing computer-executable instructions for performing the computer process on the computing system of claim 16, wherein the notification includes a plot of the estimated near wellbore friction data.

18. The one or more tangible non-transitory computer-readable storage media storing computer-executable instructions for performing the computer process on the computing system of claim 16, wherein the computing device includes at least one of a smartphone, a tablet, a desktop computer, a laptop computer, or a personal computing device.

19. The one or more tangible non-transitory computer-readable storage media storing computer-executable instructions for performing the computer process on the computing system of claim 15, wherein the pressure data includes a wellhead pressure, and the flow rate data includes an injection rate.

20. The one or more tangible non-transitory computer-readable storage media storing computer-executable instructions for performing the computer process on the computing system of claim 15, the computer process further comprising:
determining one or more well parameters using the estimated near wellbore friction data, the one or more well parameters include at least one of fluid velocity, pressure drop for plain water, pressure drop for a given gel and proppant concentration, pipe friction, perforation entry hole friction, or near wellbore tortuosity friction.
